(19) United States
(12) Patent Application Publication
(10) Pub. No.: US 2005/0187498 A1
(43) Pub. Date: Aug. 25, 2005

(54) Vibrating roller ball massage device

(76) Inventor: Edward W. Miller, Salem, OR (US)

Correspondence Address: Carl D. Crowell, P.O. Box 923, Salem, OR, 97308, US

(21) Appl. No.: 10/785,779

(22) Filed: Feb. 24, 2004

(51) Int. Cl. A61H 23/02; A61H 1/00

(52) U.S. Cl. 601/72; 601/80; 601/102; 601/110

(57) ABSTRACT

A therapeutic vibrator includes a vibrating unit, a spherical roller ball adapted to be vibrated by the action of a driving source disposed within the vibrating unit, a roller ball retention cup which houses the roller ball as the diameter of the roller ball is slightly larger than the opening of the retention cup. The roller ball is captured within yet protrudes from the retention cup providing a vibrating, omni-directionally moveable rolling ball surface for applying a therapeutic affect to body parts.

### FIELD OF THE INVENTION

This invention relates to massage devices for shoulders or other parts of the body and particularly to vibrating massage devices having an omni-directional roller ball head.

### BACKGROUND OF THE INVENTION

Massage devices have been widely used for massaging stressed or strained body parts such as backs, shoulders, legs and arms. A common variety of a massage device is a vibrator. Therapeutic vibrators typically have a gripping portion for the therapist to grasp and control the device, a vibrator unit which is either energized by electric or pneumatic sources, and a head portion that translates the vibration to the body of the patient.

One common type of vibrator has a rounded head that moves along the body or area that requires treatment. This head, in some instances, is in direct communication with a vibrating source as well as a heating source allowing the therapist to apply heat while massaging with the contouring rounded head. One problem with this type of vibrator is that when used over clothing, it drags on the clothing causing pulling or in some instances, destruction of the clothing. When used on bare skin, the stationery rounded head can drag and pull on the skin on the trailing side, and on the leading side, an accumulation of skin or tissue will develop. This reduces the soothing effect and depth of the massage. In an attempt to minimize the drag and resistance felt from this type of vibrator directly on the patient's skin, massage oil or lotion is applied to the patient's skin prior to treatment. However the use of such oil or lotion can be messy, requires washing and cleanup afterwards, and can be problematic with patients having sensitive skin that may react adversely to the applied oil or lotion.

Another type of massage device is a hand-held massage tool that has a number of rotating balls fitted into a grip. The balls provide massage while allowing free movement and rotation of the balls against skin or clothing without dragging or pulling. One example of such a massage device is disclosed in U.S. Pat. No. 6,241,696 to York. This type of massage tool is effective in limited cases, but is not able to supply percussive therapy, heating, or cooling that may be required or desired by some patients and their injuries or conditions.

There is a need for a percussive or vibrating massage device that has a freely rotational head that will not drag or pull on the patient's skin or clothing, yet does not require the application of oils or lotions for those patients with sensitive skin. Additionally, this vibrating massage device needs the ability to function with the head either hot or cold for a more specific therapeutic treatment.

### SUMMARY OF THE INVENTION

The present invention is a solution to the aforementioned deficiencies in the prior art. The primary objective of the present invention is to provide an improved massage tool which affords a vibratory, muscular and skin massage for easing strain, tension, and pain and which includes an omni-directional rotating spherical roller ball head that is quickly changed between cold and hot roller balls depending upon the patient's needs and the treatment required.

Another objective of the present invention is to provide a tool with such minimal lateral friction that the use of lotions and oils is not necessary for patients with sensitive skin and intolerance to massage oils and lotions. Because the roller ball head is an omni-directional rotating ball, there is no restriction on the movement of the device over the body. Moreover, there is no pulling or abrasive rubbing caused by the roller ball not turning in a particular direction. Further, the reciprocating head of the device facilitates the floating of the roller head, permitting the use of the invention at greater pressure and duration without adverse consequences for improved therapy. Consequently, the device affords a comfortable, thorough percussive massage.

These and other objectives, advantages and features of the present invention will become more apparent from the following description of the preferred embodiment of the invention taken in conjunction with the accompanying drawings.

### BRIEF DESCRIPTION OF THE DRAWINGS

Referring to the drawings, wherein like reference numerals indicate like parts throughout figures;

FIG. 1 is a perspective view of an improved percussive massage device embodying the principles of the present invention;

FIG. 2 is a sectional view showing the principle parts of the preferred embodiment of the present invention;

FIG. 3 is a sectional view showing an alternate embodiment of the present invention; and

FIG. 4 is an exploded view depicting the mounting and assembly of the roller ball massage portion of the invention to the vibrating means.

### DETAILED DISCUSSION OF THE PREFERRED EMBODIMENTS

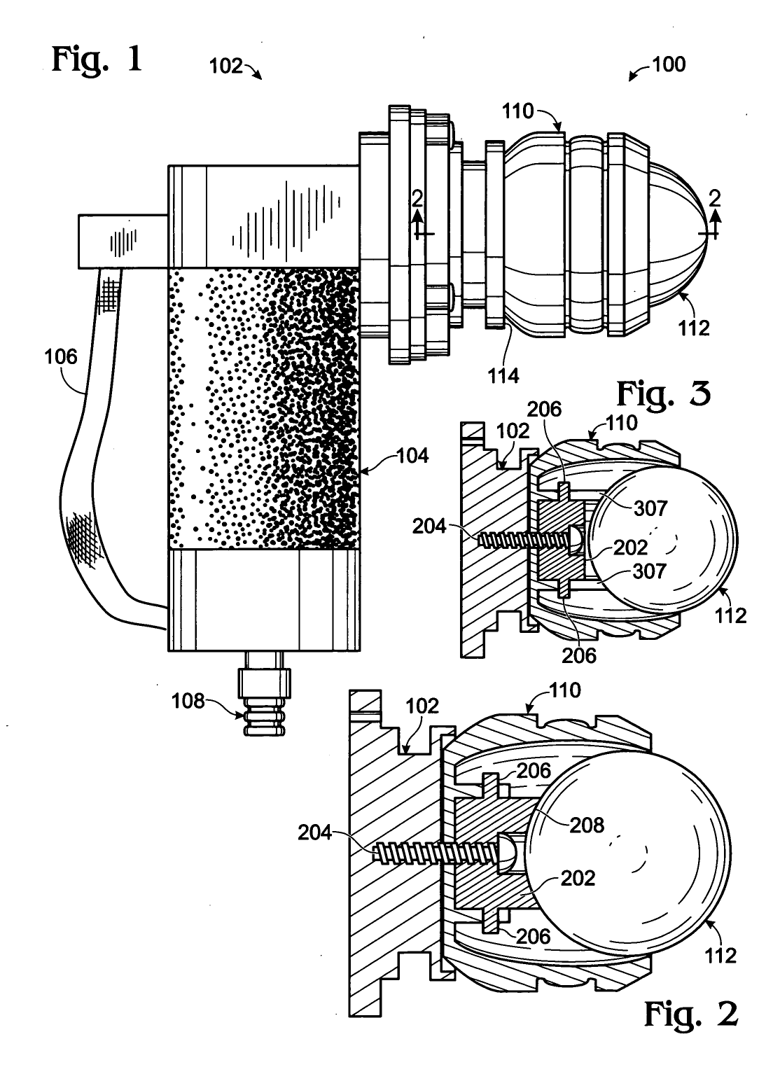

Referring to the FIGS. 1, 2, 3 and 4, the percussive device is shown. FIG. 1 is a perspective view of an improved vibrating massage device embodying the principles of the present invention. Vibrator Assembly 100 is shown in its fully assembled state. A Vibrating Unit 102 is attached to Roller Ball Retention Cup 110 at Vibrator Face 114 which contains Roller Ball 112. Roller Ball 112 is of a slightly larger diameter than Retention Cup Opening 111 of Roller Ball Retention Cup 110. This differing diameter allows Roller Ball 112 to be held inside of Roller Ball Retention Cup 110 while having a large portion of Roller Ball 112 protruding from Retention Cup Opening 111 thereby allowing adequate Roller Ball 112 surface to be used for a contouring percussive therapy or massage even over clothing.

Handle 104 with Hand Strap 106, is attached to Vibrating Unit 102 to provide means for grasping and applying pressure to Vibrating Unit 102 thereby applying pressure to Roller Ball 112 translating a rolling, vibratory massage to the patient's body. In this preferred embodiment, the vibration motion is cam driven by a conventional electric motor connected to a Power Source 108 at the end of Handle 104 opposite that of the Vibrating Unit 102. Alternate embodiments may include a pneumatic drive to facilitate the vibrating function of Vibrator Assembly 100.

FIG. 2 is a sectional view showing the principle parts of the preferred embodiment of the present invention. Roller Ball 112 is held inside Roller Ball Retention Cup 110 through Retention Cup Opening 111 where Retention Cup Opening 111 is of a slightly smaller diameter than the diameter of Roller Ball 112. Roller Ball 112 rests within Roller Ball Retention Cup 110 against Roller Ball Seat 202. Roller Ball Seat 202 preferably has a Concave Seat Face 208 that facilitates smooth surface contact between Roller Ball 112 and Roller Ball Seat 202 providing the smoothest rolling of Roller Ball 112. Roller Ball Seat 202 is preferably constructed from Nylon or other hard smooth plastic.

Roller Ball Seat 202 is placed with Roller Ball Retention Cup 110 by placing the Seat Mount Lobes 206 into corresponding seat mount lobe slots 306 provided in the Seat Collar 307 located in the bottom of Roller Ball Retention Cup 110 in order to keep Roller Ball Seat 202 from rotating. In the preferred embodiment, Roller Ball Seat 202 is slightly conical, with the lower portion being of a smaller diameter than the upper portion. Seat Collar 307 is respectively matched to permit Roller Ball Seat 202 to both securely affix Roller Ball Retention Cup 110 to Vibrating Unit 102 and to limit creep or any lateral travel.

Seat Mounting Screw 204 is threaded through Countersunk Hole 304 in the center of Roller Ball Seat 202. Mounting Screw 204 then passes through Roller Ball Retention Cup 110 and screws into Vibrator Unit 102. This connection provides direct vibratory communication between Vibrator Unit 102 and Roller Ball 112 through Roller Ball Seat 202 as there is minimal lateral and longitudinal movement of Roller Ball 112 within Roller Ball Retention Cup 110 as Roller Ball 112 is closely seated against Roller Ball Seat 202. This configuration provides a vibration to Roller Ball 112 that is realized by the massage recipient while the conforming, tight fit minimizes the friction between Roller Ball 112, Roller Ball Seat 202, and Retention Cup Opening 111. Additionally, a minimal gap is realized between Roller Ball 112 and Roller Ball Retention Cup 110, therefore there is no opportunity to catch material or skin between Roller Ball 112 and Roller Ball Retention Cup 110. Smooth fitting of components also limits noise produced by components when in use.

An alternate embodiment, depicted in FIG. 3 is disclosed wherein Seat Collar 307 has an upper parameter that is contoured to fit to Roller Ball and Roller Ball Seat 202 resides within and below Seat Collar 307 such that Roller Ball 112 rests against Seat Collar 307 reducing the surface contact of Roller Ball 112 permitting freer rotation.

To facilitate free movement of Roller Ball 112, and to provide wear points it is disclosed that coatings or pads of a material such as Teflon™ may be used on Concave Seat Face 208 or on the Seat Collar 307 at points of contact.

Roller Ball 112 is preferably constructed from an inflexible material such as steel, ceramic, hard polyurethane, nylon, or hard plastic. Roller Ball 112 is easily inserted into Roller Ball Retention Cup 110 through Retention Cup Opening 111 by placing Roller Ball 112 into Retention Cup Opening 111 and firmly tapping Roller Ball 112 through Retention Cup Opening 111. Roller Ball Retention Cup 110 is preferably constructed from Delrin®, polypropylene or another such plastic that has minimal flexibility, but enough flexibility to allow Roller Ball 112 to be forced through Retention Cup Opening 111 without damaging Roller Ball Retention Cup 110 or the roller ball 112.

To remove Roller Ball 112 from within Roller Ball Retention Cup 110, Roller Ball Retention Cup 110 and its contents are unscrewed as a single unit from Vibrating Unit 102 by twisting Roller Ball Retention Cup 110 counterclockwise thereby unscrewing Seat Mounting Screw 204 from Vibrating Unit 102. In the preferred embodiment the Roller Ball Seat 202 also acts as Roller Ball 112 ejector. Since the diameter of Roller Ball 112 is only slightly greater than the diameter of Retention Cup Opening 111, by hitting the end of Seat Mounting Screw 204 on a table or counter, Roller Ball 112 is expelled from Roller Ball Retention Cup 110 by Roller Ball Seat 202. It has also been contemplated that Roller Ball Retention Cup 110 be a two part assembly that could itself be unscrewed or separated and Roller Ball 112 removed in that way. Further contemplated developments include the use of multiple Roller Ball 112 and Roller Ball Retention Cup 110 components used in tandem to create a multiple Roller Ball 112 unit affixed to a single drive unit (Not pictured).

Often, depending upon the circumstances surrounding the muscle or body part being treated, Roller Ball 112 may be more effective hot or even cold. Since it is so fast and easy to remove and insert Roller Ball 112, several hot and cold roller balls can be used in one treatment session to either alternate hot and cold treatments or just to change the intensity of the temperature of Roller Ball 112. Temperature preparation for Roller Ball 112 is as simple as storing a desired quantity of Roller Balls 112 in either an ice water bath or a heated bath. Depending on the desired thermal properties for treatment, Roller Ball 112 may be constructed of ceramic, steel, plastic or other material with the desired thermal properties.

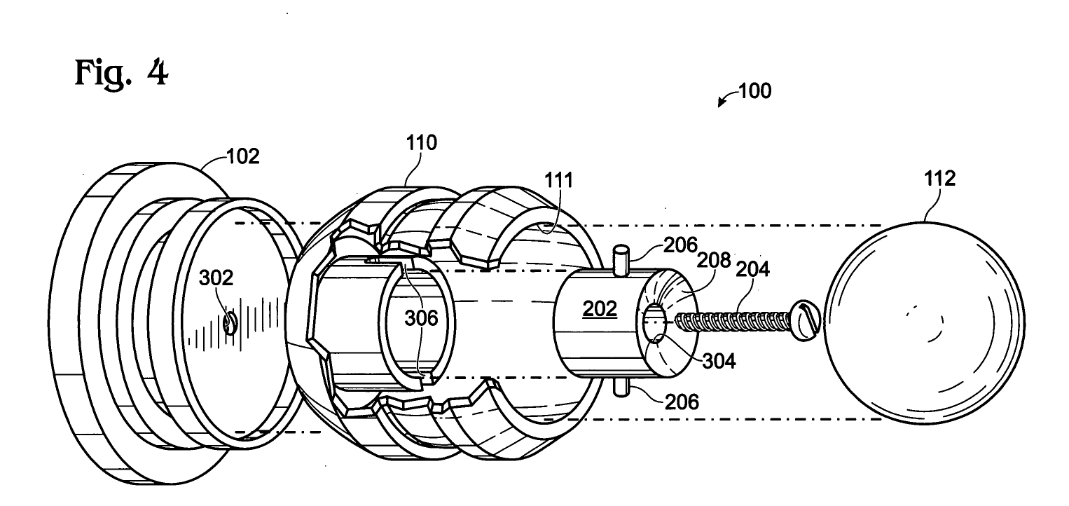

FIG. 4 is an exploded view depicting the mounting and assembly of the roller ball massage portion of the invention to the Vibrating Unit 102. Vibrating Unit 102 has a Seat Screw Threaded Hole 302 threaded into the Vibrator Face 114 of Vibrating Unit 102. There is a corresponding hole in the center of Roller Ball Retention Cup 110. Furthermore, there is a corresponding threaded Seat Mounting Screw Thru Hole 304 disposed in the center of Roller Ball Seat 202.

In assembly, Seat Mounting Screw 204 is threaded into Roller Ball Seat 202. Roller Ball Seat 202 is then inserted into the Seat Collar 307. Seat Mount Lobes 206 are slid into Seat Mount Slots 306. Mounting Screw 204 is then inserted through the hole in center of Roller Ball Retention Cup 110, and screwed into Seat Screw Threaded Hole 302 thereby holding all components tightly against Vibrating Unit 102. Roller Ball 112 is firmly tapped into Retention Cup Opening 111.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

1. A vibrator comprising:
a vibrating unit;
a roller ball adapted to be vibrated by the action of a driving source disposed within said vibrating unit, said roller ball having a spherical shape and a ball diameter;
affixed to said vibrating unit, a roller ball retention cup for housing said roller ball.

2. The vibrator of claim 1 wherein said roller ball retention cup has a round cup opening at a first end, said cup opening having a diameter slightly smaller than said ball diameter.

3. The vibrator of claim 1, wherein said driving force is an electric motor.

4. The vibrator of claim 1, wherein said driving force is a pneumatic motor.

5. The vibrator of claim 1, wherein said roller ball is ceramic.

6. The vibrator of claim 1, wherein said roller ball is steel.

7. The vibrator of claim 1, wherein said roller ball is hard plastic.

8. The vibrator of claim 1, wherein said roller ball is nylon.

9. The vibrator of claim 1, wherein said roller ball moves omni-directionally.

10. A vibrator comprising:
a vibrating unit;
a roller ball adapted to be vibrated by the action of a driving source disposed within said vibrating unit, said roller ball having a spherical shape and a ball diameter;
a roller ball retention cup for housing said roller ball, said roller ball retention cup having a round cup opening at a first end, said cup opening having a diameter slightly smaller than said ball diameter, and having a base at a second end opposite said first end, said base having a base hole disposed in the center of said base;
a roller ball seat for supporting said roller ball, said roller ball seat having a first seat end and a second seat end, said second seat end is a concave shape surface that accepts the contour of said roller ball, said roller ball seat having a seat hole disposed through the center of said roller ball seat from said first seat end to said second seat end; and
a seat mounting screw, wherein said seat mounting screw goes through said seat hole and is recessed below said seat second end, goes through said base hole of said roller ball retention cup and screws into said vibrating unit thereby fixedly attaching said roller ball retention cup to said vibrating unit.
